(19) United States
(12) Patent Application Publication
(10) Pub. No.: US 2011/0209197 A1
(43) Pub. Date: Aug. 25, 2011

(54) WEB-BASED AUDIT SYSTEM AND RELATED AUDIT TOOL

(76) Inventor: Donna Sardanopoli, Allendale, NJ (US)

(21) Appl. No.: 13/032,553

(22) Filed: Feb. 22, 2011

Related U.S. Application Data
(60) Provisional application No. 61/338,726, filed on Feb. 23, 2010.

(51) Int. Cl. H04L 9/32

(52) U.S. Cl. 726/1

(57) ABSTRACT

A web-based audit system and related tool implemented by a computer or personal digital assistant providing user with access to the internet, comprising access to a repository of audit content; wherein said audit content is associated with appropriate regulatory rules, notices policies and information ; a means to update said regulatory rules, notices, policies and information associated with said audit content with changes.

This application claims the benefit of U.S. provisional application No. 61/338,726 filed Feb. 23, 2010, which is incorporated herein in its entirety by reference.

### FIELD OF THE INVENTION

The present invention relates to an audit system and related audit tool which is multifunctional and can be used in any industry for any audit. More particularly, the invention is a web-based system and audit tool for conducting branch audits.

### BACKGROUND OF THE INVENTION

Wall Street is experiencing an unprecedented event with the merging of the 2 rule books. It is currently an environment where laws, rules, and regulations are constantly changing. This makes it very difficult and time consuming for firms to gather and integrate the vast amount of changes that are published by regulators and incorporate all these ongoing amendments into the firm's audit content. The invention audit tool and system provides visibility and analysis around the ever-evolving rules. With using this solution, firms will NOT have to devote compliance resources to this large cost and labor intensive process of continually updating their branch audit content, branch audit procedures and firm policies to the new rules and regulations. The invention provides this service and more.

Securities regulations, Rule 3010(c) require that broker-dealers perform branch office inspections every one to three years. These requirements are intended to help broker-dealers identify regulatory rule violations in addition to areas in need of improvement and to develop corrective action plans to ensure their firms are in compliance with the rules. In many cases, branch audits are done manually using desktop applications or paper-based processes. These time-consuming methods make it difficult to maintain consistency among audits, integrate the vast amount of information/rules published by regulators and assimilate the ever evolving rules to the actual audit review. As firms grow through mergers and acquisitions, the surviving Broker Dealers need to get their arms around the branches they have acquired and get a quick understanding where they are at risk. The invention tool provides a tool for them to use which mirrors the current Regulatory Exams.

The invention system provides audit creation and scheduling controlled by a central management system with access given to audit managers and auditors. These audits are performed by the audit staff over the internet.

The invention tool simplifies the examination process by helping compliance personnel and the examination staff, maintain an efficient and consistent workflow in addition to compliance with NASD Rule 3010.

The invention tool mirrors a regulatory audit that would prepare broker dealers for an actual regulatory branch exam (audit). The invention discloses findings that regulators typically discover. The invention may assist the firm in avoiding large monetary fines and sanctions which is usually the result of many branch audits that are performed by regulators.

The invention system aggregates information (Rules, Regulatory Notices, etc.) from various regulatory bodies and streamlines the content to appropriate audit chapters.

Each audit question, within the body of the audit, has linked to it:
1. Up-to-date applicable regulatory rules (SEC, FINRA and NYSE);
2. Actual audit procedure (step by step instructions for the auditor on how to perform the review);
3. All applicable FINRA Regulatory Notices and NYSE Information Memos;
4. Preconfigured to include the firms policies;
5. Audit Notes area to summarize the reviews; and
6. Audit Violations area to summarize the findings

Among other enhancements the invention also provides:
A Registered Representative questionnaire which mirrors a regulatory exam with ability to add questions as needed;
A Branch Manager Interview which mirrors a regulatory exam with ability to add questions);
A Web-based response application - Response/Violation Tracker;
A Violation Tracker Corrective Action- which provides automatic notification of completed corrective action; and
Build as you go ability to add preconfigured audit questions to tailor it specifically to each firm or company.

Since every company or individual has different needs, the invention platform is designed to be highly configurable and adaptable, so each company or individual can choose to add content that best addresses any additional policies and procedures.

The invention platform can be used to perform an actual audit in addition to training the Broker Dealer's Internal Branch Audit Group.

The invention system can be used for any internal audit performed within the firm. New content can be added and it would facilitate the same needs. Complying with the applicable regulatory rules for that specific department (research, syndicate, etc.) and utilized as a training tool for auditors.

Audit tools are known in the art. A representative example of an audit tool used for regulatory branch audits is owned by Compliance Solutions Inc. herein referred to as “Compliancemax”. The invention audit system and tool is distinct and unique from that provided by Compliancemax (www.compliancemax.com). Unlike the Compliancemax technology the invention provides a unique web based audit tool and system including the following features.

Chapter Selection—where the user can select one or all of the chapters to complete the audit; each audit is tailored to that specific user's audit needs.

Data Capture and reporting technologies—Data collected by auditors and data collected by associated persons.

The ability to upload and attach work papers.

The ability to prepare a violation report which is sent electronically via email to the Manager;

Web based response application where the Manager sends the response report electronically via email to audit team.

Corrective action application wherein the Manager then responsible for sending to audit team when corrective action has been completed. This is done through a web based corrective action application named the “Violation Tracker” to provide an instant automatic notification of the completed corrective action that is sent by Manager. This holds the management team accountable for rectifying all violations;

Report cannot be archived unless all corrective actions are completed.

Provides a build as you go-add, edit and delete function.

Graphical reporting of audit activities statuses and results.

The invention model and related audit tool has many more advantages and enhancements over known tools as represented in the Compliancemax system.

For example, the invention contains methodologies which streamline certain reviews that are usually done manually in a branch audit. Saving the auditor hours even days in performing the audit (i.e. the dissemination and analysis of the Registered Rep questionnaires performed through the web based tool

The invention tool includes copy written content which mirrors (content) a FINRA regulatory examination—prepping branches for a regulatory exam in addition to facilitating the need for firms to comply with NASD Rule 3010(c).

The invention model helps the firms avoid the large cost and labor intensive process of developing new content and continually updating to the new rules and regulations. (Compliance Mapping). The continuously changing environment of laws, rules, and regulations makes it very time consuming to gather and integrate the vast amount of information published by regulators. The invention model aggregates this information (Rules and Regulatory Notices) from various regulatory bodies and streamlines the content to appropriate audit chapters>Connecting Audit Question to Regulatory Rules to Audit Procedures and ultimately tailoring to each firm by connecting it to the firms updated polices. This last point is very important when describing the model It includes updating all content to the ongoing changes of the regulatory rules>updates rules which then can update the audit questions, audit procedure, and firm policies. No other system provides this feature.

A further object of this invention is that the model can be used as a training tool for auditors >Educate and train auditors on Regulatory Rules and Audit Procedures—(function Compliancemax definitely does not have/There is no audit tool that does provide the content along with the technology as this invention does).

Yet still another object of the invention is that the model can be used for any audit performed within any industry. New content would be added and it would facilitate the same needs. Complying with the applicable regulatory rules for that specific Industry/department (Brokerage, Anti-Money Laundering, Banking, Insurance, Healthcare), Compliance mapping of all information and utilized as a training tool for auditors which is a function the prior art and Compliancemax definitely does not have.

### SUMMARY OF THE INVENTION

In the present invention, these purposes, as well as others which will be apparent are achieved generally by providing a web-based audit system implemented by a computer or personal digital assistant providing user with access to the internet, comprising access to a repository of audit content; wherein said audit content is associated with appropriate regulatory rules, notices policies and information and a means to update said regulatory rules, notices, policies and information associated with said audit content with changes.

The web-based audit system further comprises a web based response application wherein violations are sent electronically to management team accountable for responding to and correcting said violations. Wherein the responses by said management team must be completed by the management team and sent electronically to Audit Team.

The web-based audit system further comprises a violations tracker, which is an automatic notification of the completed corrective actions that is also sent by branch management. This notifies the audit team that corrective action has been put in place and as of what day it was completed.

The invention also provides a web-based audit tool and system comprising the steps of: providing a user log-in to web-based platform; providing a welcome page for the user(audit Manager/auditor)-built in roles system that allows certain users certain capabilities The system provides a user log-in to a web-based platform; a welcome page for the user.

The Audit Manager has the capability to assign an audit, Perform an audit, Review and Edit an audit, Close an audit and Archive an audit. The Auditor has the capability to Perform a new audit, Review and Edit, Close an audit and Archive an audit for (x) number of years desired for books and records purposes.

A Profile page is provided wherein user provides information on the company; a Document request list and interview pages are provided which provide the user with the audit material to perform; an online Questionnaire application is provided and completed by registered individuals associated with the audit.

A list of audit chapters wherein the user selects appropriate chapters needed for the audit is provided. The body of the Audit comprising chapters wherein each chapter contains questions and the ability to answer questions; review applicable rules; audit procedures; work papers; exhibits; other references; firm policy; make customized notes; and detail violations; ability to attach work papers to the web-based platform server.

The auditor's attestation for completing applicable chapters is provided.

Printing reports which detail the completed review and/or only the violations; and saving the report electronically.

A web based response application violation tracker is provided which permits the manager being audited to respond to each audit finding and said Manager is responsible for sending to the audit team electronically. The Branch manager also gets a copy of his responses because he is now obligated to report to the audit team as to when he has performed the corrective actions. This is done through the Violation Tracker

The invention also provides a web based Violation Tracker corrective action which is an instant automatic notification of the completed corrective actions that is also sent by branch management. This notifies the audit team that corrective action has been put in place and as of what day it was completed. This holds the management team accountable for rectifying all violations.

Reports cannot be archived unless all corrective actions are completed.

In a preferred embodiment, the web-based audit system is used to conduct a branch audit. However, the system is not limited to just branch audits and maybe used to conduct audits in any industry including brokerage, anti-money laundering, banking, insurance, healthcare, etc.

The invention also includes a web-based audit tool used in the system.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 is a schematic of the web-based audit system according to the invention; and

FIG. 2 is a schematic of the, web-based audit system according to another embodiment of the invention.

### DETAILED DESCRIPTION OF THE INVENTION

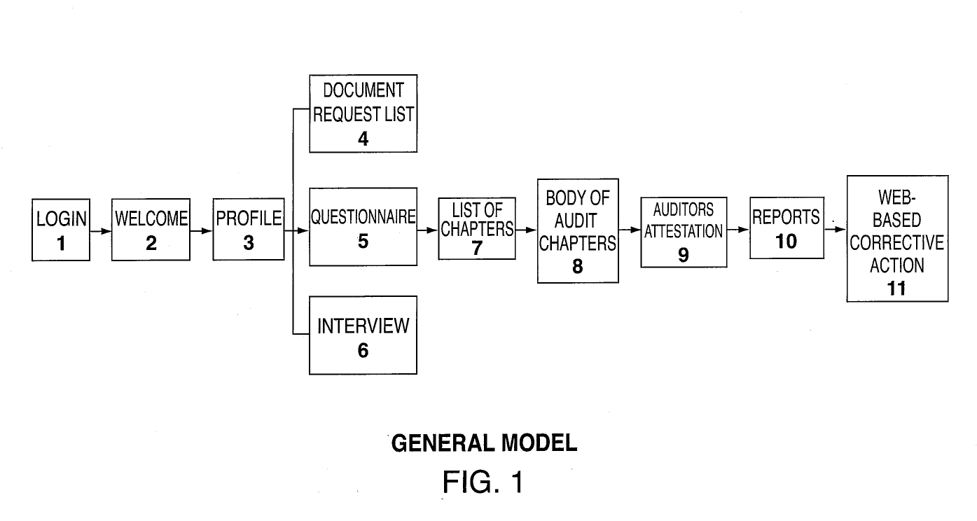

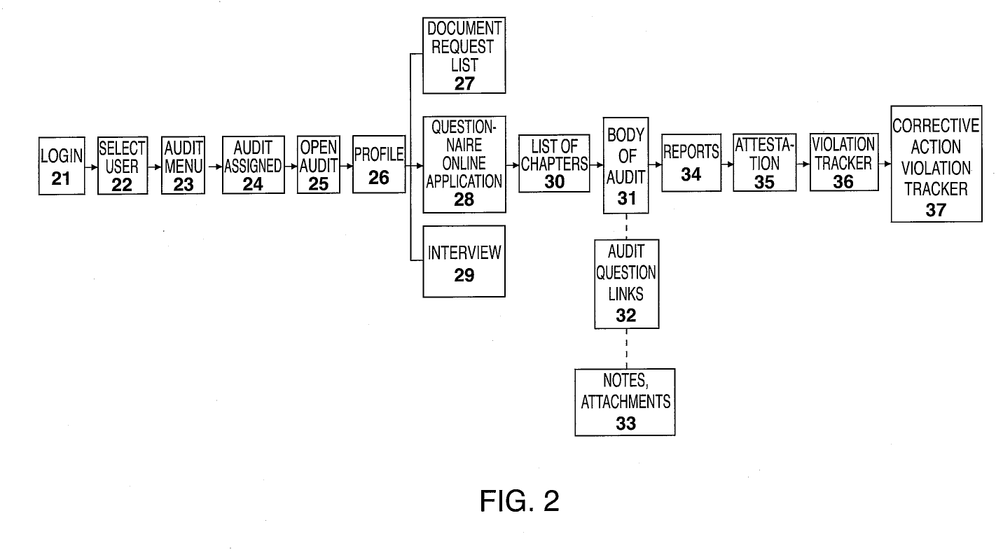

In accordance with the present invention the web-based audit system is illustrated in FIGS. 1 and 2. FIG. 1 outlines the stream-lined steps of the web-based system according to the invention and FIG. 2 outlines the more detailed steps used in a branch audit.

As shown in FIG. 1, the user logs in at the Login 1 page to begin the audit.

At the Welcome 2 page for the auditor and/or audit manager selects the appropriate function:
New Audit, creating an audit,
Assign Audit—once created it's assigned to an auditor,
Open Audit—once assigned to an auditor it can be reviewed or edited. It's considered a working audit.
Closed a closed audit and
Archived an audit

The Profile 3 page provides information the auditor retrieves from the compliance department in order to complete the parameters of the document request list.

The Document Request List 4, the Questionnaire 5 for the Manager to complete for the auditor's review and the Manager interview 6 which the auditor needs to perform are all completed through applications accessed on the internet.

The List of Audit Chapters 7 in the system is determined based on the framework/business being audited.

The Body of the audit 8 contains chapters with relevant questions and the ability for the auditor to answer the questions on the internet. Next to each question the auditor has the choice of either selecting Y for yes; N for no; N/A for not applicable as answers.

Additional links are also provided for the auditor next to each question. These auditor links are marked with a “?”. When the user scrolls over the “?” a Rule summary including all applicable regulatory rules (SEC, FINRA, NYSE) to the question will appear. There also is a violations, notes and attachment option available to the auditor next to each question.

Once the audit is completed the Auditors attestation 9 is provided and Reports 10 can be generated.

The system provides a unique web-based Response Violation tracker and web-based corrective action/Violation Tracker 11 which is described in more detail below in discussing FIG. 2.

As shown in FIG. 2, the user logs in at the Login 21 and selects user 22 to begin the audit.

At the Audit Menu 23 the auditor and/or audit manager selects the appropriate function:
New Audit, creating an audit,
Assign Audit—once created it's assigned to an auditor,
Open Audit—once assigned to an auditor it can be reviewed or edited. It's considered a working audit.
Closed a closed audit and
Archived an audit

The Audit is assigned 24 and opened 25 by the auditor to begin the audit. The Profile 26 provides information the auditor retrieves from the compliance department in order to complete the parameters of the document request list.

The Document Request List 27, The Questionnaire 28, in the case of a Branch audit is for each registered person to complete for the auditor's review and the Manager interview 29 which the auditor needs to perform are all completed through applications accessed online.

The List of Audit Chapters 30 in the system is determined based on the framework/business being audited. In the case of a branch audit the list of Chapters include:
A. Branch Administration/Registration;
B. Review of Customer Complaints;
C. Review of New Account Documentation;
D. Review of Customer Identity Program (CIP);
E. Review of Customer Accounts;
F. Review of Producing Branch Office Managers (BOM);
G. Review of Registered Representatives on Heightened/Special Supervisions/Statutory Disqualified Individuals (SD's);
H. Review of Remote/Physical Locations/Regulation SP;
I. Review of Discretionary Accounts;
J. Review of Employee/Employee Related Accounts;
K. Review of Employee/Employee Related Outside Accounts;
L. Review of Outside Activities/Private Securities Transactions/Sharing in Profit or Losses; Joint Accounts;
M. Review of Electronic and Written Communications;
N. Review of Advertising/Marketing and Seminars (Radio Broadcasts);
O. Review of Order Tickets and Confirmations;
P. Review of Account Designation Changes (Cancel/Rebills) and Order Errors;
Q. Review of Regulation T Extensions and Restricted Accounts;
R. Review of Bounced. Checks;
S. Review of “P.O. Box”/“Care Of”/“Hold Mail” Accounts;
T. Review of Customer Change of Address;
U. Review of Letters of Authorization;
V. Review of Safeguarding Customer Funds and Securities;
W. Review of Currency (Bank Secrecy ACT)

The auditor will check an (X) in the box next to the chapters that are needed for each audit. This allows the auditor to tailor the audit to each specific branch. There maybe times the auditor may not need all 23 chapters, depending on what functions the branch performs.

Body of the audit 31, the 23 chapters A to W listed above, each contain relevant questions and the ability to answer the questions.

Links 32 are provided for the auditor next to each question. These auditor links are marked with a “?”. When the user scrolls over the “?” a Rule summary including all applicable regulatory rules (SEC, FINRA, NYSE) to the question will appear.

Audit Procedures 32 which are step by step instructions for the auditor on how to perform the review.

Workpapers/Exhibits 32 suggestions to the auditor as to what backup to collect as evidence of review.

Other References 32 include all applicable FINRA Regulatory Notices and additional regulatory guidance for the auditor.

The Firm Policy 32 feature is tailored to the individual brokerage firm. The auditor will now have on his laptop all applicable regulatory rules and firm policies—which is what the auditor is reviewing for—to make sure the firm is complying with all applicable rules and also the firm's policies.

The Notes 33 box enables the auditor to write an overview of the review they performed and the text is saved and becomes part of the final report.

The Violations Box enables the auditor to detail the violation. The text is saved and becomes part of the final report. A completed violations box will produce a response box and will become part of the electronic report the manager receives.

The auditor is also provided with functionality to upload attachments (actual workpaper exhibits) onto the server.

There are certain reviews within a branch audit that are very tedious. The invention provides unique methodologies which streamline certain reviews. Instead of the auditor performing the reviews manually they are performed using the invention web based audit.

The-invention, tool provides the ability to upload and save work papers to the server; the Auditor's attestation for completing all applicable chapters; and the ability to print 2 audit reports; one which details the completed review and one which details only the violations. All reports created may also be saved electronically.

The Web based response application (Response/Violation Tracker) 36 provides a means to report violations to the Managers. They receive the violation report via email and are obligated to respond to each audit finding requiring corrective or remedial action.

A completed violation box will produce a response box. The manager will open the response box and detail what remedial action the branch is taking in response to the violation. The system will not allow the response report to be sent back to the audit team until all responses are completed.

The Manager also receives a copy of this response report with an added box to input Corrective Action Completed. The Manager then is responsible for sending to audit team when corrective action has been completed. This is done through a web based corrective action application which has been named the Corrective Action Violation Tracker 37 which is an instant automatic notification of the completed corrective action that is sent by manager. This holds the management team accountable for rectifying all violations.

Reports generated cannot be archived unless all corrective actions are completed.

This requires Branch Office Managers to take direct responsibility of the finding. Supervisors are designated to receive automatic notification once the branch level corrective actions are completed

Results can be viewed immediately through a web reporting system.

Graphical reporting of audit activities statuses and results are also available to the user.

In the preferred embodiment according to the illustration in FIG. 2, where a branch audit is conducted, the invention model each audit question has linked to it the following:
Up-to-date applicable regulatory rules (SEC, FINRA, NASD and NYSE);
Actual audit procedure (step by step instructions for the auditor on how to perform the review);
All applicable FINRA Regulatory Notice, NYSE Information Memos AND NASD Notice to members which still apply;
Suggestions for Workpaper exhibits;
Preconfigured to include the firms policies;
Audit Notes area to summarize the reviews. The existing systems i.e. Compliancemax, does not give the auditor the autonomy to write their own notes and details to the review. Their audit notes and violation are preprogrammed which the auditor need to choose from. This does not give a true and accurate picture of the violation. It is a cookie cutter way of performing an audit;
Audit Violations area to summarize the findings—the current systems i.e. Compliancemax does not give the auditor the autonomy to write their own notes and details to the violation. Their audit notes and violation are preprogrammed which the auditor need to choose from .This does not give a true and accurate picture of the violation. It is a cookie cutter way of performing an audit;
Ability to upload and attach work papers;
Build as you go-add, edit and delete function;
Response Violation Tracker which the violation report sent to the branch manager and the ability for the branch manager to respond to violation;
Corrective Action Violation Tracker which is an instant automatic notification of the completed corrective action that is sent by manager; and
Graphical reporting of audit activities statuses and results.

Among other advantages the invention also provides a Registered Representative Questionnaire. This content mirrors a regulatory exam with the added ability to add, edit and delete questions. The proprietary methodology streamlines this review. An online application is provided where each producing branch manager and broker receives the audit code in order to log into the questionnaire from their own desktops, to complete and submit. These answers are saved and sorted as part of the Audit. The auditor is then able to review these answers in a way that will streamline this view. This replaces what is usually done during a manual review.

The Branch Manager Interview provides content that mirrors a regulatory exam with the added ability to add, edit and delete questions.

It provides the ability to upload and attach work papers

The violation report is sent electronically via email to the Manager. The Response Violation Tracker is the web based response application where the Manager sends the response report electronically via email to audit team. The Manager is then responsible for reporting to the audit team when corrective action has been completed. This is done through a web based corrective action application which has been named the Corrective Action Violation Tracker which is an instant automatic notification of the completed corrective action that is sent by manager. This holds the management team accountable for rectifying all violations.

Reports cannot be archived unless all corrective actions are completed

Build as you go-add, edit and delete function i.e. ability to add preconfigured audit questions to tailor it specifically to each firm is provided by the invention tool. This is needed because at times some of the firm's policies might be more conservative than the actual regulatory rule.

The functionality is based on a built in Roles System that allows certain users certain capabilities The system provides a user log-in to a web-based platform; a welcome page for the user. Audit Manager has the capability to Assign an audit, Perform an audit, Review and Edit an audit, Close an audit and Archive an audit. The Auditor has the capability to Perform a new audit, Review and Edit, Close an audit and Archive an audit for (x) number of years desired for books and records purposes; a profile page wherein user provides information on the company; a document request list which can be saved on the server and sent via email to the manager being audited; Manager interview (provide the user with the audit material to perform) which is completed by auditor and uploaded and saved on the server; a list of audit chapter wherein the user selects appropriate chapters needed for the audit; questionnaire via online application described above(which provide the user with the audit material to perform); a body of the Audit comprising chapters wherein each chapter are questions and the ability to answer questions; review applicable rules; audit procedures; work papers; exhibits; other references; firm policy; make customized notes; and detail violations; ability to attach work papers to the server(ability to select specific chapters for each audit, tailoring each audit performed), an auditor's attestation for completing applicable chapters; the ability to print reports which detail the completed review and then send the violation report to the manager (being audited) via email; the ability to save the report electronically;

A web based response application (Response/Violation Tracker) where the Manager sends the response report electronically via email to audit team; The Manager also receives a copy of this response report with an added box to input Corrective Action Completed. The Manager then is responsible for sending to audit team when corrective action has been completed. This is done through a web based corrective action application which has been named the Corrective Action Violation Tracker which is an instant automatic notification of the completed corrective action that is sent by the manager. This holds the management team accountable for rectifying all violations. Reports cannot be archived unless all corrective actions are completed. Graphical reporting of audit activities statuses and results are then available to the user.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. A web-based audit system implemented by a computer or personal digital assistant providing user with access to the internet, comprising access to a repository of audit content; wherein said audit content is associated with appropriate regulatory rules, notices policies and information;
a means to update said regulatory rules, notices, policies and information associated with said audit content with changes.

2. The web-based audit system according to claim 1, further comprising a violations tracker, wherein violations are sent electronically to management team accountable for correcting said violations.

3. The web-based audit system according to claim 2, wherein corrective action by said management team must be completed prior to completing and archiving the audit report.

4. A web-based audit tool comprising the steps of:
providing a user log-in to web-based platform;
providing an audit menu for said user to select from the group consisting of a new audit, assign audit, open audit, closed audit and archive audit;
providing a Profile page wherein user provides information on a company being audited;
providing a Document request list and interview pages which provides said user with the audit material to perform;
providing an online Questionnaire application completed by registered individuals associated with the audit;
providing a list of audit chapters wherein the user selects appropriate chapters needed for the audit;
providing the body of the Audit comprising said selected audit chapters wherein said selected chapters contain questions and the ability to answer said questions; review applicable rules, audit procedures, work papers, exhibits, other references and firm policy; make customized notes; and
detail violations; the ability to attach work papers to the web-based platform server;
providing auditor's attestation for completing applicable chapters;
printing reports which detail the completed review and/or only the violations;
saving the report electronically;
providing a response violation tracker which is a web based response application wherein violations are sent electronically via email to person(s) accountable for responding to and correcting said violations; and
providing a corrective action violation tracker which is a web based corrective action application which is an instant automatic notification of the completed corrective action.

5. The tool according to claim 4, wherein said reports cannot be archived unless all corrective actions are completed.
